(19) United States
(12) Patent Application Publication
(10) Pub. No.: US 2025/0300595 A1
(43) Pub. Date: Sep. 25, 2025

(54) PHOTOVOLTAIC SUPPORT

(71) Applicant: Mokun Renewable Technologies Co., Ltd., Shanghai (CN)

(72) Inventors: Jiabao GUO, Shanghai (CN); Xiao LIU, Shanghai (CN)

(21) Appl. No.: 18/863,978

(22) PCT Filed: May 9, 2023
(86) PCT No.: PCT/CN2023/092972

§ 371 Date: Nov. 7, 2024

(30) Foreign Application Priority Data
May 11, 2022 (CN) 202221206530.8

(51) Int. Cl. H02S 20/32

(52) U.S. Cl. CPC H02S 20/32

(57) ABSTRACT

Provided in the present disclosure is a photovoltaic support, comprising a purlin and inclined struts, the upper end of the inclined struts being connected to the purlin by means of two first fasteners passing through and connecting two pairs of connection holes, respectively, each pair of connection holes of the two pairs of connection holes comprising a first connection hole disposed on the purlin and a second connection hole correspondingly disposed on the inclined strut, and the two pairs of connection holes being staggered both in the height direction and in the length direction of the purlin. The photovoltaic support described above is capable of effectively preventing the purlin from deforming.

### TECHNICAL FIELD

The present disclosure relates to a photovoltaic support.

### BACKGROUND ART

Photovoltaic power generation is currently a form of new energy heavily developed by various countries. It has the characteristics of being safe, environmentally friendly and emissions-free. In photovoltaic power generation applications, photovoltaic support are essential components in photovoltaic power generation systems, and play a role in supporting, mounting, and fixing photovoltaic modules, ensuring that photovoltaic modules are not damaged by wind, rain, snow and other harsh environments and ensuring the structural strength of photovoltaic systems.

The main components of photovoltaic support with conventional steel structures typically consist of columns, inclined beams, inclined struts, purlins and the like. In order to ensure the stability of the support structure, inclined struts are typically required to connect the purlin with the column, or the purlin with the main beam, so that the purlin and column/main beam form a triangular support, so that the position of the purlin is correct and the strength meets the requirements. The upper part of the inclined struts is supported at an angle in the middle position of the purlin. The lower part of the inclined struts is connected to a purlin supporting member, the main beam, or the like, and the purlin supporting member is also referred to as purlin support.

Typically, the connection is in the form of a bolted hinge between the inclined struts and the purlin, and between the inclined struts and the purlin support. However, the inventors discovered that with such a connection structure, the connection plane between the inclined struts, purlin support, and purlin may freely rotate in a parallel direction, which is not conducive to the stability of the support structure. Particularly under the action of external forces such as strong winds, the purlin is prone to deformation and twisting. Moreover, deformation of the purlin further loosens the connection between the inclined struts and the purlin and even between the inclined struts and the purlin support.

Therefore, there is a need to provide a photovoltaic support that is capable of effectively preventing deformation of the purlin.

### SUMMARY OF THE UTILITY MODEL

The object of the present disclosure to provide a photovoltaic support that is capable of effectively preventing deformation of the purlin.

Provided in the present disclosure is a photovoltaic support, comprising a purlin and inclined struts, characterized in that the upper end of the inclined struts is connected to the purlin by means of two first fasteners passing through and connecting two pairs of connection holes, respectively, each pair of connection holes of the two pairs of connection holes comprising a first connection hole disposed on the purlin and a second connection hole correspondingly disposed on the inclined strut, and the two pairs of connection holes being staggered both in the height direction and in the length direction of the purlin.

In an embodiment, the inclined strut has a width center plane in the width direction of the inclined strut. The two second connection holes that belong to the two pairs of connection holes on the inclined strut are located on both sides of the width center plane, respectively.

In an embodiment, the inclined strut is a component that is symmetric with respect to the width center plane. The upper end of the inclined strut is disposed with four connection holes, of which two connection holes located on the diagonal side relative to the width center plane constitute the two second connection holes that belong to the two pairs of connection holes.

In an embodiment, the center of the four connection holes constitutes four corner points of a rectangle, respectively.

In an embodiment, the second connection hole is a circular hole. The first connection hole is an elongated hole extending along the length direction.

In an embodiment, the photovoltaic support comprises two inclined struts. The photovoltaic support further comprises a purlin support which both ends are connected to the lower end of the two inclined struts by means of second fasteners passing through and connecting a pair of through holes, respectively, the pair of through holes comprising a first through hole disposed on the purlin support and a second through hole correspondingly disposed on the inclined strut.

In an embodiment, one end of the purlin support is connected to the lower end of the corresponding inclined strut by means of two second fasteners passing through and connecting two sets of a pair of through holes, respectively.

In an embodiment, the inclined strut has a width center plane in the width direction of the inclined strut. The center of the two sets of the pair of through holes is located on the width center plane.

In an embodiment, the second through hole is a circular hole. The first through hole is an elongated hole extending along the length direction.

In an embodiment, the purlin has a height center plane in the height direction. The two first connection holes that belong to the two pairs of connection holes on the purlin are located on both sides of the height center plane, respectively.

In the photovoltaic support described above, since the inclined strut and purlin are connected by means of two pairs of connection holes that are staggered both in the height direction and length direction of the purlin, the inclined strut and the purlin cannot be rotated with respect to each another, effectively preventing deformation of the purlin, regardless of the wind direction, and has good anti-deformation effects. Moreover, the photovoltaic support described above is capable of further preventing loosening of the mounting between the inclined strut and the purlin, and has anti-loosening function.

The number of spare parts involved in the photovoltaic support described above is not much different than that of photovoltaic support that use conventional purlin and inclined strut connection methods. The photovoltaic support has a simple overall structure, and is convenient to manufacture and mount, low-cost, and reliable.

### DESCRIPTION OF ACCOMPANYING DRAWINGS

The aforementioned and other characteristics, nature and advantages of the present disclosure will be further highlighted below in conjunction with the following accompanying drawings and description of examples, wherein

FIG. 1 is a schematic diagram showing a partial construction of an exemplary photovoltaic support:

FIG. 2 is a schematic diagram showing a partial construction of another exemplary photovoltaic support.

FIG. 3A is a bottom view of an exemplary purlin.

FIG. 3B is a side view of an exemplary purlin.

FIG. 3C is a top view of an exemplary purlin.

FIG. 4A is a side view of an exemplary inclined strut.

FIG. 4B is a cross-sectional view of an exemplary inclined strut.

FIG. 5A is a side view of an exemplary purlin support.

FIG. 5B is a cross-sectional view of an exemplary purlin support.

FIG. 5C is a top view of an exemplary purlin support.

### SPECIFIC EMBODIMENTS

The present disclosure will be further described below with specific embodiments and accompanying drawings. More details are described in the following description to facilitate thorough understanding of the present disclosure. However, the present disclosure can obviously be embodied through different methods other than those described and those skilled in the art may promote and interpret this based on the actual application without deviating from the content of the present disclosure. Therefore, the scope of protection of the present disclosure should not be limited by the content of the specific embodiments.

For example, a first characteristic subsequently recorded in the Specification is formed above or on a second characteristic, may include embodiments in which the first characteristic and the second characteristic are formed by direct contact, and may also include embodiments in which additional characteristics are formed between the first characteristic and the second characteristic, so that there may be no direct contact between the first characteristic and the second characteristic. Further, when a first element is described by connecting or combining with a second element, the description includes embodiments in which the first element and the second element are directly connected or combined with each other, and also includes the addition of one or more other intervening elements to indirectly connect or combine the first element and the second element with each other.

Typically, the purlin and inclined strut may be in the form of a C-shaped, U-shaped, x-shaped, or square tube-shaped strip cold-bent member. The inventors discovered that when the connection between the inclined struts and purlin, and the inclined struts and the purlin support, particularly the inclined struts and purlin is in the form of a bolted hinge, the inclined struts and purlin may freely rotate relative to each other, which is not conducive to the stability of the overall structure of the photovoltaic support. According to the analysis of the inventors, if no other reinforcement measures are taken, the upper portion of the photovoltaic support is in an unstable state, which may cause excessive stress and deformation of the photovoltaic support under the impact of strong winds or heavy snow.

According to the further analysis of the inventors, changing the conventional single-bolt hinged inclined strut connection from hinged connection to fixed connection by means of two pairs of connection holes, and having the two pairs of connection holes being staggered in the height direction and length direction of the purlin effectively avoids the phenomenon of purlin deformation.

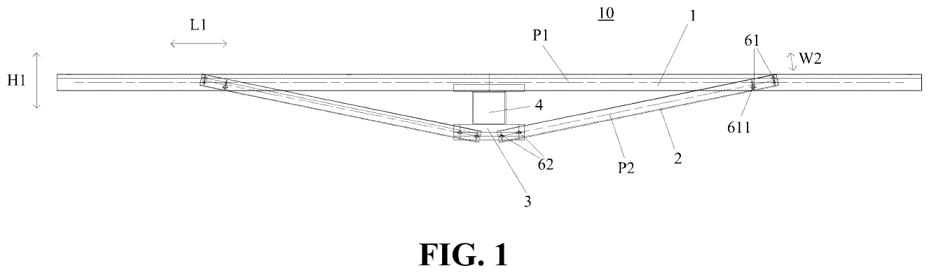

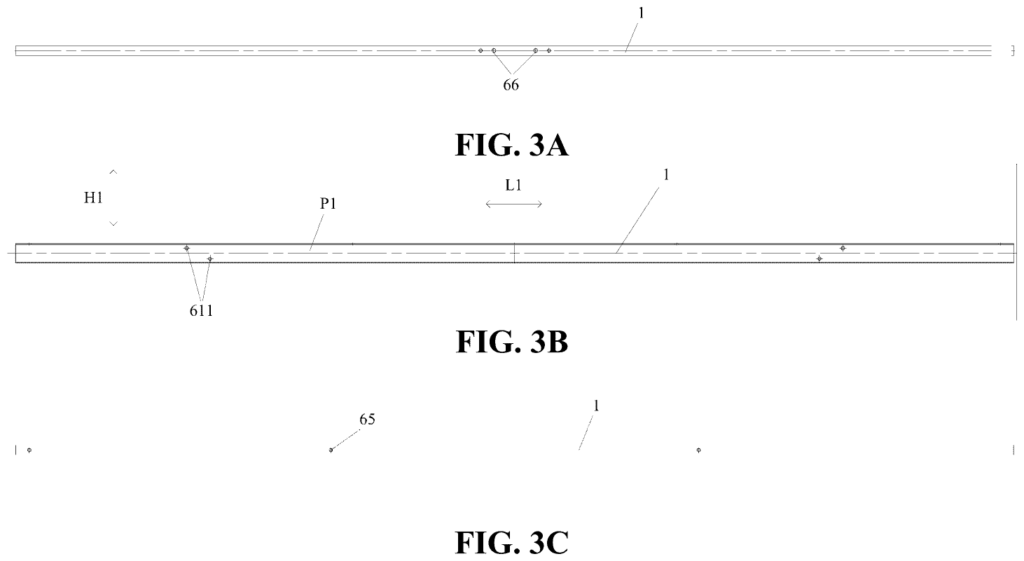

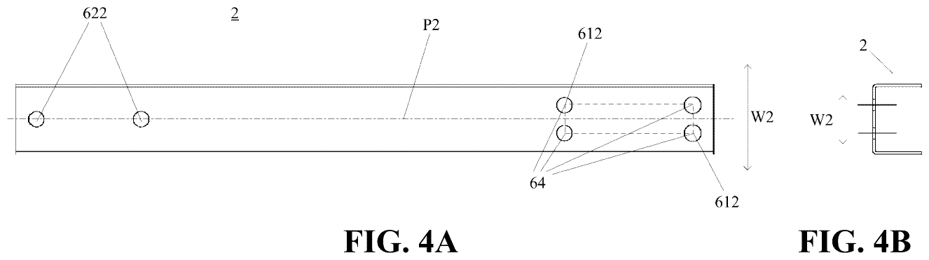

FIG. 1 exemplarily shows a schematic diagram of a photovoltaic support 10 provided according to the present disclosure. The photovoltaic support 10 comprises a purlin 1 and inclined struts 2. FIGS. 3A-3C exemplarily show a three-sided construction of a purlin 1, respectively, while FIGS. 4A-4B exemplarily a two-sided construction of an inclined strut 2, respectively.

With reference to FIGS. 1 and 3A-4B, the upper end of the inclined strut 2 is connected to the purlin 1 by means of two first fasteners (not shown) passing through and connecting two pairs of connection holes 61, respectively. Each pair of connection holes 61 in the two pairs of connection holes 61 comprises a first connection hole 611 (shown in both FIGS. 1 and 3B) disposed on the purlin 1 and a second connection hole 612 (shown in FIG. 4A) correspondingly disposed on the inclined strut 2. The two pairs of connection holes 61 are staggered in the height direction H1 and the length direction L1 of the purlin 1.

The purlin 1 is an elongated rod member in the photovoltaic support 10 which upper part is used to mount the photovoltaic module, typically supported on the main beam 4 of the photovoltaic support 10. The main beam 4 is typically located at a center position along the length direction L1 of the purlin 1. Also shown in FIG. 3C is a fixing hole 65 on the purlin 1 for fixing the photovoltaic module. The cross-section of the purlin 1 may, for example, be C-shaped, U-shaped, a square tube, or T-shaped.

The inclined strut 2 is an elongated strut member in the photovoltaic support 10 that connects the purlin 1 and main beam 4, and columns (not shown) to form a triangular support between the purlin 1 and columns/main beam 4. The upper part of the inclined strut 2 is supported at a certain angle in the middle position of the purlin 1. The lower part, for example, may be supported on the main beam 4, the purlin support 3 described later, or the column. The cross-section of the inclined strut 2 may, for example, be C-shaped, U-shaped (as shown in FIG. 4B), a square tube, or T-shaped.

The length direction L1 of the purlin 1 is also the extension direction of the purlin 1. The height direction H1 of the purlin 1 is also the direction perpendicular to the length direction L1 of the purlin 1 and the extension direction of the main beam 4 supporting thereof, i.e., the vertical direction of the photovoltaic support 10 when it is upright on the ground, for example, by means of the column.

It should be understood that the words “first”, “second”, and the like used in the text to define the characteristics only facilitate the differentiation of the corresponding characteristics. Unless stated otherwise, the above words have no special meaning, so they cannot be understood as limiting the scope of protection of the present disclosure. For example, the aforementioned first fastener and the second fastener to be described later are merely for making a distinct description of fasteners used in different locations, both of which may be in various fastener forms such as bolts, screws, and the like.

By connecting the two pairs of connection holes 61 by means of the two first fasteners, respectively, the purlin 1 and the inclined struts 2 may be fixedly connected into one unit to prevent angle deviation of the purlin 1 under the impact of gravity, wind pressure and snow pressure. At the same time, the two pairs of connection holes 61 are staggered in the height direction H1 and the length direction L1 of the purlin 1, which improves the stability of the upper purlin 1, so that the purlin 1 does not lose stability due to only having a single point of connection with the inclined struts 2. The stress on the purlin 1 and inclined struts 2 is smaller than that of a hingedly connected purlin and inclined struts. Hence, the overall strength of the purlin 1 and inclined struts 2 is greatly improved.

It should be understood that the two directions referred to herein, namely “perpendicular,” “consistent,” “parallel,” and the like, do not need to meet strict mathematical angle requirements, but a range of tolerances is allowed, for example, a difference of within 20° from the mathematically required angle. By “along” a certain direction or “in a certain direction”, it refers to at least a component in the direction. Preferably, the included angle to the direction is within 45°. More preferably, the included angle is within 20° or even 5°.

As shown in FIG. 1, the inclined struts 2 have a width center plane P2 in the width direction W2 of the inclined struts 2, i.e., a plane located in the center of the inclined struts 2 in the width direction W2. The two pairs of second connection holes 612 that belong to the aforementioned two pairs of connection holes 61 on the inclined struts 2 may be located on both sides of the width center plane W2, i.e., on the left and right sides in FIG. 1. Such arrangement may optimize the staggered distribution of the two pairs of connection holes 61 in the height direction H1 and the length direction L1.

It should be understood that the use of specific words in the text to describe embodiments of the present disclosure, such as “an embodiment,” “another embodiment,” and/or “some embodiments” refer to a certain characteristic, structure, or feature associated with at least one embodiment of the present disclosure. Thus, it should be emphasized and noted that references to “an embodiment” or “another embodiment” in the Specification two or more times at different locations do not necessarily refer to the same embodiment. Further, certain characteristics, structures, or features in one or more embodiments of the present disclosure may be appropriately combined.

As shown in FIG. 4A, the inclined strut 2 may be a component that is symmetrical with respect to the width center plane P2. Four connection holes 64 may be disposed on the upper end of the inclined strut 2. That is, the four connection holes 64 are also arranged symmetrically with respect to the width center plane P2.

Among the four connection holes 64, two connection holes 64 located on the diagonal side relative to the width center plane P2 may respectively constitute the two second connection holes 612 that belong to the two pairs of connection holes 61, as indicated in FIG. 4A. In this way, a batch of the same inclined struts 2 is made, which may be suitable as the inclined struts 2 on the left and right sides in FIG. 1, i.e., so that the inclined struts 2 are interchangeable.

Referring to FIG. 4A, the center of the aforementioned four connection holes 64 may constitute four corner points of a rectangle, respectively. That is, the line connecting the centers of the aforementioned four connection holes 64 form a rectangular shape, and two diagonal connection holes in the four connection holes 64 are connected with the inclined strut 2.

In the embodiment shown in FIG. 4A, the second connection hole 612 may be a circular hole. As shown in FIG. 1, the first connection hole 611 may be an elongated hole that may extend along the length direction L1. Disposing elongated holes is conducive to adjustment of position and mounting alignment. Disposing the elongated holes on the purlin 1 may be conducive to the symmetric arrangement of the previously mentioned inclined struts 2. It should be understood that in another embodiment, the first connection hole 611 disposed on the purlin 1 may also be a circular hole, as shown in FIG. 3A.

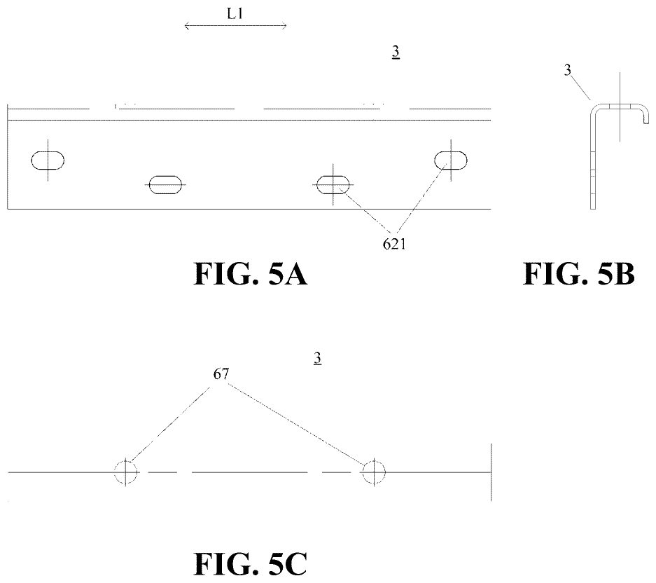

As shown in FIG. 1, the photovoltaic support 10 comprises two inclined struts 2. The photovoltaic support 10 may further comprise a purlin support 3. FIGS. 5A-5C exemplarily show a three-sided construction of the purlin support 3, respectively.

Both ends of the purlin support 3 may connect the lower ends of the two inclined struts 2 by means of a second fastener (not shown) passing through and connecting a pair of through holes 62, respectively. The pair of through holes 62 may comprise a first through hole 621 disposed on the purlin support 3 and a second through hole 622 correspondingly disposed on the inclined strut 2.

The purlin support 3 may be placed below the main beam 4, and may also be referred to as the lower supporting member of the purlin. The purlin support 3 may, for example, be connected to the purlin 1 by means of bolts, i.e., the purlin support 3 and the purlin 1 may be clamped on the main beam 4 by means of this bolted connection. For example, bolt holes 66 of the purlin 1 for connecting the pair of through bolts are shown in FIG. 3A and bolt holes 67 of the purlin support 3 for connecting the pair of through bolts are shown in FIG. 5C. The purlin support 3, the two inclined struts 2 and the purlin 1 jointly constitute a stable inverted trapezoidal structure, forming a stable support, in particular ensuring that the connectors do not slide in the axial direction, wherein, the purlin support 3 may extend substantially parallel to the purlin 1, while the two inclined struts 2 are located on both sides, respectively, the inverted trapezoidal structure being substantially symmetrical on both sides relative to the main beam 4. As shown in FIG. 5B, the purlin support 3 may be a bending member.

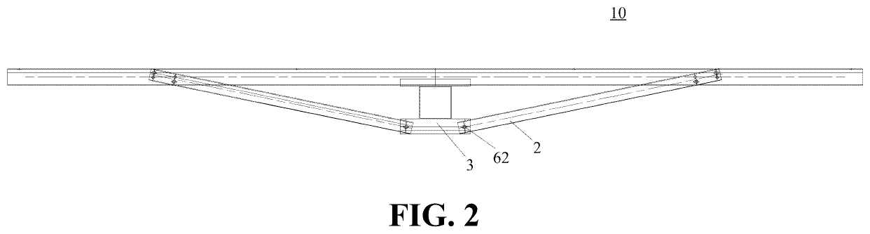

In the embodiment shown in FIG. 1, one end of the purlin support 3 may be connected to the lower end of the corresponding inclined struts 2 by means of two second fasteners passing through and connecting the two sets of the pair of through holes 62. In this way, the rotation between the purlin support 3 and the inclined struts 2 may be prevented, effectively preventing the connection plane between the inclined struts 2 and the purlin support 3, as well as the entire purlin from loosening. In another embodiment, one end of the purlin support 3 may also be connected to the lower end of the corresponding inclined struts 2 by means of only one second fastener passing through and connecting a set of the pair of through holes 62, as shown in FIG. 2.

As previously described, the inclined strut 2 has a width center plane P2 in the width direction W2 of the inclined strut 2. As shown in FIG. 1, the center of the two sets of the pair through holes 62 may each be located on the width center plane P2.

As shown in FIG. 4A, the second through hole 622 may be a circular hole. As shown in FIG. 5A, the first through hole 621 may be an elongated hole that may extend along the length direction L1 of the purlin 1.

As shown in FIG. 1, the purlin 1 has a height center plane P1 in the height direction H1, i.e., a plane located in the center of the purlin 1 in the height direction H1. The two first connection holes 611 that belong to the two pairs of connection holes 61 on the purlin 1 may be located on both sides of the height center plane P1, i.e., the upper and lower sides in FIG. 1, respectively. Such an arrangement may result in more stable support of the purlin 1.

For conventional single-bolt hinged inclined strut connection structures, the purlin tends to deform and twist, and purlin deformation further leads to loosening of the mounting. In particular, when the purlin is C-shaped steel, it saves material, but it has poor rigidity and deforms easily.

In the photovoltaic support described above, two holes are opened at both sides of the purlin connection with the inclined strut, and the location of the two holes is the same as that of the holes for mounting the inclined strut. That is, in the photovoltaic support described above, the connection structure of the purlin and inclined strut is changed from hinged connection to fixed connection by means of connection holes at two positions, which staggers the connection holes in the length direction and the height direction to prevent deformation of the purlin and makes it less prone to relatively large deformations of the triangular support structure due to gravity or wind or snow pressure. This ensures that the assemblies in the upper portion are in an accurate position and straightly mounted, preventing loosening. Therefore, the photovoltaic support described above may be particularly suitable where the C-shaped steel is used for the purlin.

The number of spare parts of the photovoltaic support described above may be substantially the same as that of conventional photovoltaic support. The photovoltaic support has a simple overall structure, and is convenient to manufacture and mount, low-cost and reliable.

Although preferred examples of the present disclosure are disclosed above, they are not used to limit the present disclosure and those skilled in the art may make changes and amendments without departing from the spirit and scope of the present disclosure. Therefore, as long as the content does not depart from the technical solution of the present disclosure, any amendments, equivalent changes and modifications to the above examples based on the technical essence of the present disclosure fall into the scope of protection defined in the Claims of the present disclosure.

1-10. (canceled)

11. A photovoltaic support, comprising
a purlin and inclined struts,
wherein the upper end of the inclined struts is connected to the purlin by means of two first fasteners passing through and connecting two pairs of connection holes, respectively;
each pair of connection holes of the two pairs of connection holes comprising a first connection hole disposed on the purlin and a second connection hole correspondingly disposed on the inclined strut; and
the two pairs of connection holes being staggered both in the height direction and in the length direction of the purlin.

12. The photovoltaic support according to claim 11, wherein
the inclined strut has a width center plane in the width direction of the inclined strut; and
the two second connection holes that belong to the two pairs of connection holes on the inclined strut are located on both sides of the width center plane, respectively.

13. The photovoltaic support according to claim 12, wherein
the inclined strut is a component that is symmetric with respect to the width center plane; and
the upper end of the inclined strut is disposed with four connection holes, of which two connection holes located on the diagonal side relative to the width center plane constitute the two second connection holes that belong to the two pairs of connection holes.

14. The photovoltaic support according to claim 13, wherein
the center of the four connection holes constitute four corner points of a rectangle, respectively.

15. The photovoltaic support according to claim 11, wherein
the second connection hole is a circular hole; and
the first connection hole is an elongated hole extending along the length direction.

16. The photovoltaic support according to claim 11, wherein the photovoltaic support comprises two inclined struts; and
the photovoltaic support further comprises a purlin support which both ends are connected to the lower end of the two inclined struts by means of second fasteners passing through and connecting a pair of through holes, respectively, the pair of through holes comprising a first through hole disposed on the purlin support and a second through hole correspondingly disposed on the inclined strut.

17. The photovoltaic support according to claim 16, wherein
one end of the purlin support is connected to the lower end of the corresponding inclined strut by means of two second fasteners passing through and connecting two sets of a pair of through holes, respectively.

18. The photovoltaic support according to claim 17, wherein
the inclined strut has a width center plane in the width direction of the inclined strut; and
the center of the two sets of the pair of through holes is located on the width center plane.

19. The photovoltaic support according to claim 16, wherein
the second through hole is a circular hole; and
the first through hole is an elongated hole extending along the length direction.

20. The photovoltaic support according to claim 11, wherein
the purlin has a height center plane in the height direction; and
the two first connection holes that belong to the two pairs of connection holes on the purlin are located on both sides of the height center plane, respectively.

21. A method of providing a photovoltaic support, the method comprising:
providing a main beam of a photovoltaic tracking support in communication with a platen;
providing the platen in communication with a first arc bearing;
providing the first arc bearing in communication with a bearing base;
connecting a first roller to the bearing base, the first roller in communication with an arcuate outer sidewall of the arc bearing; and
connecting a second roller connected to the bearing base, the second roller in communication with an arcuate inner sidewall of the arc bearing.

22. The method of providing a photovoltaic support according to claim 21, wherein the inclined strut has a width center plane in the width direction of the inclined strut; and
the two second connection holes that belong to the two pairs of connection holes on the inclined strut are located on both sides of the width center plane, respectively.

23. The method of providing a photovoltaic support according to claim 22, wherein the inclined strut is a component that is symmetric with respect to the width center plane; and
the upper end of the inclined strut is disposed with four connection holes, of which two connection holes located on the diagonal side relative to the width center plane constitute the two second connection holes that belong to the two pairs of connection holes.

24. The method of providing a photovoltaic support according to claim 23, wherein the center of the four connection holes constitute four corner points of a rectangle, respectively.

25. The method of providing a photovoltaic support according to claim 21, wherein the second connection hole is a circular hole; and
the first connection hole is an elongated hole extending along the length direction.

26. The method of providing a photovoltaic support according to claim 21 further comprising:
providing at least two inclined struts; and
providing a purlin support which both ends are connected to the lower end of the two inclined struts by means of second fasteners passing through and connecting a pair of through holes, respectively, the pair of through holes comprising a first through hole disposed on the purlin support and a second through hole correspondingly disposed on the inclined strut.

27. The method of providing a photovoltaic support according to claim 26 further comprising:
connecting one end of the purlin support to the lower end of the corresponding inclined strut by means of two second fasteners passing through and connecting two sets of a pair of through holes, respectively.

28. The method of providing a photovoltaic support according to claim 27, wherein the inclined strut has a width center plane in the width direction of the inclined strut; and
the center of the two sets of the pair of through holes is located on the width center plane.

29. The method of providing a photovoltaic support according to claim 26, wherein the second through hole is a circular hole; and
the first through hole is an elongated hole extending along the length direction.

30. The method of providing a photovoltaic support according to claim 21, wherein the purlin has a height center plane in the height direction; and
the two first connection holes that belong to the two pairs of connection holes on the purlin are located on both sides of the height center plane, respectively.
